(19) United States
(12) Patent Application Publication
(10) Pub. No.: US 2013/0300631 A1
(43) Pub. Date: Nov. 14, 2013

(54) ANTENNA WITH FEEDER AND ELECTRONIC DEVICE

(71) Applicant: HON HAI PRECISION INDUSTRY CO., LTD., New Taipei (TW)

(72) Inventor: TSUNG-LIN HSIEH, New Taipei (TW)

(73) Assignee: HON HAI PRECISION INDUSTRY CO., LTD., New Taipei (TW)

(21) Appl. No.: 13/865,252

(22) Filed: Apr. 18, 2013

(30) Foreign Application Priority Data
May 11, 2012 (TW) 101117011

(51) Int. Cl. H01Q 9/06

(52) U.S. Cl. CPC H01Q 9/06
USPC 343/905; 343/700 MS

(57) ABSTRACT

An antenna includes a circuit board, a primary antenna, a secondary antenna, and a feeder. The primary antenna is n-shaped and consists of a first middle section, and a first subsection and a second subsection which are connected to the first middle section. The first subsection and the second subsection have different lengths, the first subsection has a first feed point. The secondary antenna has a second feed point which is connected therewith. The primary antenna and the secondary antenna are disposed on the circuit board, and the feeder feeds an electrical signal to the first feed point and the second feed point.

### BACKGROUND

1. Technical Field

The disclosed embodiments relate to an antenna with a feeder and an electronic device.

2. Description of Related Art

Most antennas operate in a certain frequency range. A typical antenna includes a grounding structure. When the antenna is mounted in an electronic device, the grounding structure is connected to a metal casing of the electronic device, so that the grounding structure is grounded. Commonly, when the area of the grounding structure is increased, the operation frequency range of the antenna is extended.

However, in order to extend the operation frequency range of the antenna, the area of the grounding structure needs to be increased, the volume of the antenna is increased, and therefore the miniaturization of the antenna is not realized.

Therefore, there is room for improvement in the art.

### BRIEF DESCRIPTION OF THE DRAWINGS

Many aspects of the embodiments can be better understood with reference to the drawing. The components in the drawing are not necessarily drawn to scale, the emphasis instead being placed upon clearly illustrating the principles of the present embodiments. Moreover, in the drawing, like reference numerals designate corresponding parts throughout six views.

FIG. 1 is a schematic block diagram showing an antenna in accordance with a first embodiment.

FIG. 2 is a schematic block diagram showing the antenna in accordance with a second embodiment.

FIG. 3 is a schematic block diagram showing the antenna in accordance with a third embodiment.

FIG. 4 is a graph showing measured voltage standing wave ratio (VSWR) of the antenna in FIG. 1.

FIG. 5 is a schematic block diagram showing the antenna in accordance with a fourth embodiment.

FIG. 6 is a graph showing measured VSWR of the antenna in FIG. 5.

### DETAILED DESCRIPTION

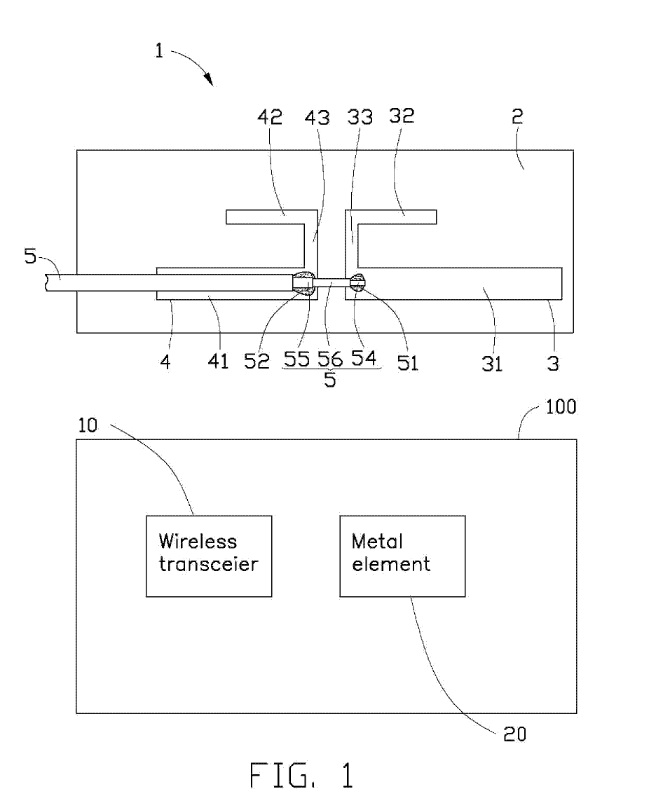

FIG. 1 shows an antenna 1 in accordance with a first embodiment. The antenna 1 includes a circuit board 2, a primary antenna 3, a secondary antenna 4, and a feeder 5. The primary antenna 3 and the secondary antenna 4 are disposed on the circuit board 2. In this embodiment, the primary antenna 3 and the secondary antenna 4 are disposed on the same surface of the circuit board 2. In other embodiments, the primary antenna 3 and the secondary antenna 4 are disposed on different surface of the circuit board 2.

The primary antenna 3 is n-shaped. The primary antenna 3 consists of a first middle section 33, a first subsection 31, and a second subsection 32. The first subsection 31 and the second subsection 32 are connected to the first middle section 33. The first subsection 31 and the second subsection 32 have different lengths, the first subsection 31 has a first feed point 51. In this embodiment, the length of the first subsection 31 is larger than the length of the second subsection 32. In other embodiments, the length of the first subsection 31 is smaller than or equal to the length of the second subsection 32.

The secondary antenna 4 is also n-shaped. The secondary antenna 4 consists of a second middle section 43, a third subsection 41, and a fourth subsection 42. The third subsection 41 and the fourth subsection 42 are connected to the second middle section 43. The third subsection 41 and the fourth subsection 42 have different lengths, the third subsection 41 has a second feed point 52. The length of the third subsection 41 is smaller than the length of the first subsection 31. In this embodiment, the length of the third subsection 41 is larger than the length of the fourth subsection 42. In other embodiments, the length of the third subsection 41 is smaller than or equal to the length of the fourth subsection 42.

The feeder 5 feeds an electrical signal to the first feed point 51 and the second feed point 52, therefore the antenna 1 is operated.

The antenna 1 is mounted in an electronic device 100, that is, the electronic device 100 can include the antenna 1. The electronic device 100 includes a wireless transceiver 10 and a metal element 20. The metal element 20 is grounded, the metal element 20 can be a metal casing of the electronic device 100. In a first embodiment, the feeder 5 is a coaxial cable 50 having an inner conductor 54, an outer conductor 55, and an insulator 56 disposed between the inner conductor 54 and the outer conductor 55. A first end of the inner conductor 54 is electrically connected to the first feed point 51, and a second end of the inner conductor 54 is connected to the wireless transceiver 10. A first end of the outer conductor 55 is electrically connected to the second feed point 52, and a second end of the outer conductor 55 is connected to the metal element 20.

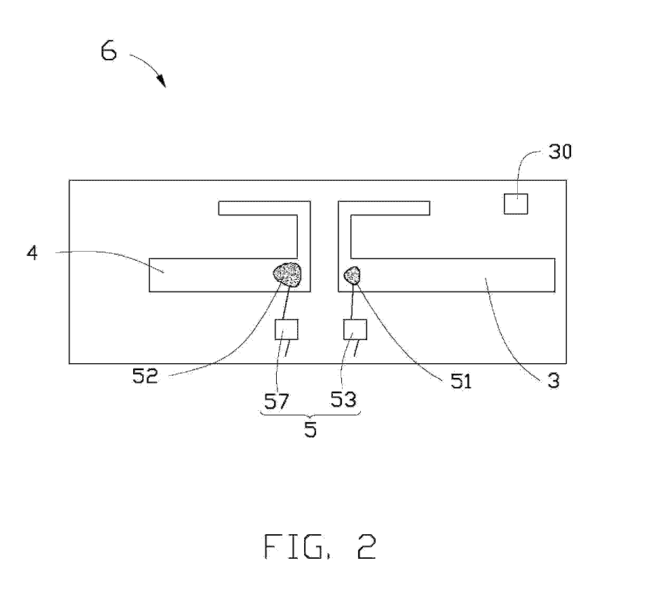

FIG. 2 shows the antenna 6 in accordance with a second embodiment. The circuit board 2 includes a grounding pin 30 being grounded. The difference between the antenna 6 and the antenna 1 in FIG. 1 is described below: the feeder 5 includes a first metal sheet 53 and a second metal sheet 57. The first metal sheet 53 and the second metal sheet 57 are soldered to the circuit board 2. A first end of the first metal sheet 53 is connected to the first feed point 51, and a second end of the first metal sheet 53 is connected to the wireless transceiver 10. A first end of the second metal sheet 57 is connected to the second feed point 52, and a second end of the second metal sheet 57 is connected to the grounding pin 30. In other embodiment, a first end of the second metal sheet 57 is connected to the second feed point 52, and a second end of the second metal sheet 57 is connected to the metal element 20.

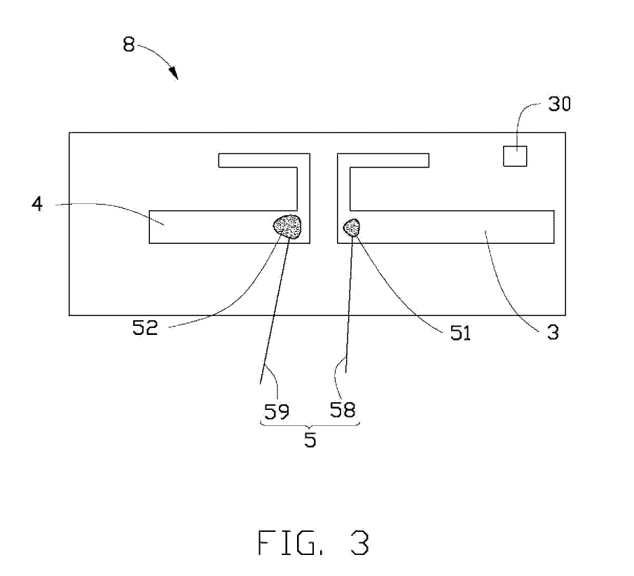

FIG. 3 shows the antenna 8 in accordance with a third embodiment. The difference between the antenna 8 and the antenna 1 in FIG. 1 is described below: the feeder 5 includes a first conducting wire 58 and a second conducting wire 59. A first end of the first conducting wire 58 is connected to the first feed point 51, and a second end of the first conducting wire 58 is connected to the wireless transceiver 10. A first end of the second conducting wire 59 is connected to the second feed point 52, and a second end of the second conducting wire 59 is connected to the grounding pin 30. In other embodiment, a first end of the second conducting wire 59 is connected to the second feed point 52, and a second end of the second conducting wire 59 is connected to the metal element 20.

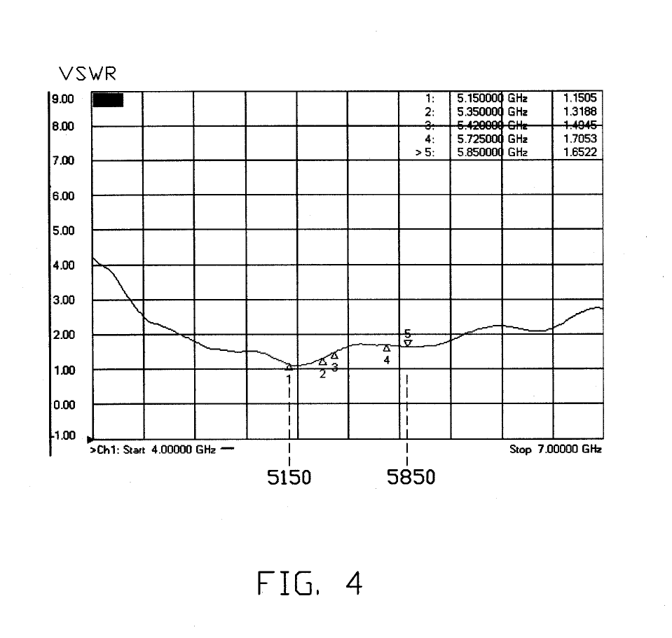

FIG. 4 shows a graph of measured voltage standing wave ratio (VSWR) of the antenna 1 in FIG. 1. The antenna 1 can be operated at frequencies ranging from 5.15 GHz to 5.85 GHz. When the antenna 1 is operated at 5.15 GHz, the VSWR is 1.1505. When the antenna 1 is operated at 5.35 GHz, the VSWR is 1.3188. When the antenna 1 is operated at 5.42 GHz, the VSWR is 1.4945. When the antenna 1 is operated at 5.725 GHz, the VSWR is 1.7053. When the antenna 1 is operated at 5.85 GHz, the VSWR is 1.6522.

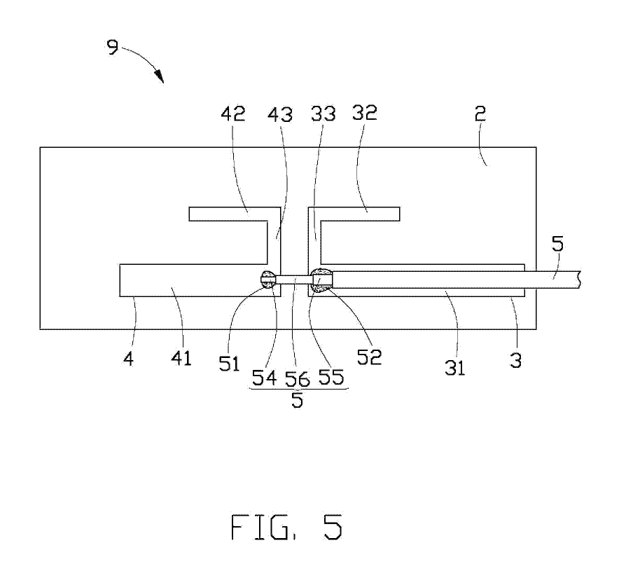

FIG. 5 shows the antenna 9 in accordance with a fourth embodiment, the length of the third subsection 41 is smaller than the length of the first subsection 31. The difference between the antenna 9 and the antenna 1 in FIG. 1 is described below: a first end of the inner conductor 54 is electrically connected to the second feed point 52, and a second end of the inner conductor 54 is connected to the wireless transceiver 10. A first end of the outer conductor 55 is electrically connected to the first feed point 51, and a second end of the outer conductor 55 is connected to the metal element 20.

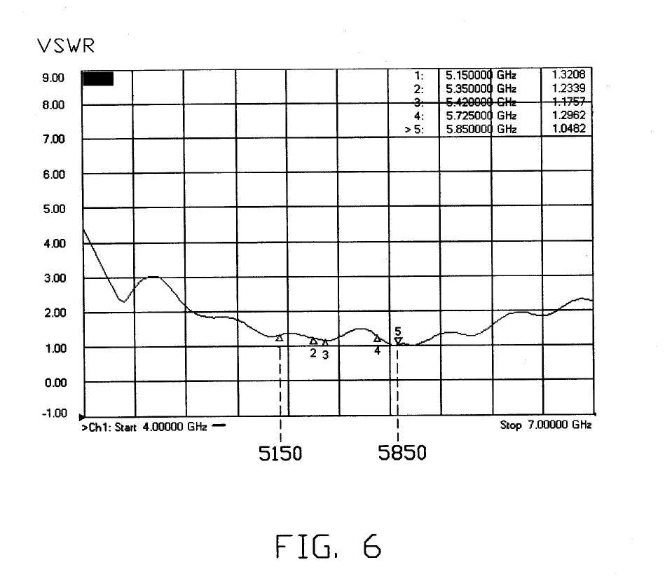

FIG. 6 shows a graph of measured VSWR of the antenna 9 in FIG. 5. The antenna 9 can be operated at frequencies ranging from 5.15 GHz to 5.85 GHz. When the antenna 9 is operated at 5.15 GHz, the VSWR is 1.3208. When the antenna 9 is operated at 5.35 GHz, the VSWR is 1.2339. When the antenna 9 is operated at 5.42 GHz, the VSWR is 1.1757. When the antenna 9 is operated at 5.725 GHz, the VSWR is 1.2962. When the antenna 9 is operated at 5.85 GHz, the VSWR is 1.0482.

The above antenna 1, 6, 8, and 9, the feeder 5 feeds the electrical signal to the primary antenna 3 and the secondary antenna 4, a first current path is generated in the primary antenna 3, and a second current path is generated in the secondary antenna 4. When the length of the first subsection 31 and/or the second subsection 32 is adjusted, the length of the first current path is also adjusted. When the length of the third subsection 41 and/or the fourth subsection 42 is adjusted, the length of the second current path is also adjusted. Because the different lengths of the first current path and/or the length of the first current path, the operation frequency range of the antenna 1, 6, 8, and 9 can be extended. Compared to the prior art, in order to extend the operation frequency range of the antenna, the volume of the antenna 1, 6, 8, and 9 can be designed small, therefore the miniaturization of the antenna 1, 6, 8, and 9 can be realized.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An antenna, comprising:
a circuit board;
a primary antenna being n-shaped and consisting of a first middle section, and a first subsection and a second subsection which are connected to the first middle section; the first subsection and the second subsection having different lengths, the first subsection having a first feed point;
a secondary antenna having a second feed point which is connected therewith; and
a feeder; wherein the primary antenna and the secondary antenna are disposed on the circuit board, and the feeder feeds an electrical signal to the first feed point and the second feed point.

2. The antenna of claim 1, wherein the secondary antenna is n-shaped and consists of a second middle section, and a third subsection and a fourth subsection which are connected to the second middle section; the third subsection and the fourth subsection have different lengths, the third subsection has the second feed point.

3. The antenna of claim 2, wherein the length of the first subsection is larger than the length of the third subsection.

4. The antenna of claim 1, wherein the length of the first subsection is larger than the length of the second subsection.

5. The antenna of claim 2, wherein the length of the third subsection is larger than the length of the fourth subsection.

6. The antenna of claim 3, wherein the antenna is mounted in an electronic device, the electronic device comprises a metal element being grounded and a wireless transceiver, the feeder is a coaxial cable having an inner conductor, an outer conductor, and an insulator disposed between the inner conductor and the outer conductor; a first end of the inner conductor is electrically connected to the first feed point, and a second end of the inner conductor is connected to the wireless transceiver; a first end of the outer conductor is electrically connected to the second feed point, and a second end of the outer conductor is connected to the metal element.

7. The antenna of claim 3, wherein the antenna is mounted in an electronic device, the electronic device comprises a metal element being grounded and a wireless transceiver, the feeder is a coaxial cable having an inner conductor, an outer conductor, and an insulator disposed between the inner conductor and the outer conductor; a first end of the outer conductor is electrically connected to the first feed point, and a second end of the outer conductor is connected to the metal element; a first end of the inner conductor is electrically connected to the second feed point, and a second end of the inner conductor is connected to the wireless transceiver.

8. The antenna of claim 1, wherein the antenna is mounted in an electronic device, the electronic device comprises a wireless transceiver; the circuit board comprises a grounding pin being grounded, the feeder comprises a first metal sheet and a second metal sheet soldered to the circuit board, a first end of the first metal sheet is connected to the first feed point, and a second end of the first metal sheet is connected to the wireless transceiver; a first end of the second metal sheet is connected to the second feed point, and a second end of the second metal sheet is connected to the grounding pin.

9. The antenna of claim 1, wherein the antenna is mounted in an electronic device, the electronic device comprises a wireless transceiver and a metal element being grounded; the feeder comprises a first conducting wire and a second conducting wire, a first end of the first conducting wire is connected to the first feed point, and a second end of the first conducting wire is connected to the wireless transceiver; a first end of the second conducting wire is connected to the second feed point, and a second end of the second conducting wire is connected to the metal element.

10. The antenna of claim 1, wherein the antenna is mounted in an electronic device, the electronic device comprises a wireless transceiver; the circuit board comprises a grounding pin being grounded, the feeder comprises a first conducting wire and a second conducting wire, a first end of the first conducting wire is connected to the first feed point, and a second end of the first conducting wire is connected to the wireless transceiver; a first end of the second conducting wire is connected to the second feed point, and a second end of the second conducting wire is connected to the grounding pin.

11. The antenna of claim 1, wherein the primary antenna and the secondary antenna are disposed on the same surface of the circuit board.

12. The antenna of claim 1, wherein the primary antenna and the secondary antenna are disposed on the different surface of the circuit board.

13. An electronic device, comprising:
a wireless transceiver;
a metal element being grounded; and
an antenna, comprising:
a circuit board;
a primary antenna being n-shaped and consisting of a first middle section, and a first subsection and a second subsection which are connected to the first middle section; the first subsection and the second subsection having different lengths, the first subsection having a first feed point;
a secondary antenna having a second feed point which is connected therewith; and
a feeder feeding an electrical signal to the first feed point and the second feed point;
wherein the primary antenna and the secondary antenna are disposed on the circuit board, the feeder comprises a first metal sheet and a second metal sheet, the first metal sheet and the second metal sheet are soldered to the circuit board, a first end of the first metal sheet is connected to the first feed point, and a second end of the first metal sheet is connected to the wireless transceiver; a first end of the second metal sheet is connected to the second feed point, and a second end of the second metal sheet is connected to the metal element.

14. The electronic device of claim 13, wherein the secondary antenna is n-shaped and consists of a second middle section, and a third subsection and a fourth subsection which are connected to the second middle section; the third subsection and the fourth subsection have different lengths, the third subsection has the second feed point.

15. The electronic device of claim 14, wherein the length of the first subsection is larger than the length of the second subsection, and the length of the third subsection is larger than the length of the fourth subsection.

16. An electronic device, comprising:
a wireless transceiver;
a metal element being grounded; and
an antenna, comprising:
a circuit board;
a primary antenna being n-shaped and consisting of a first middle section, and a first subsection and a second subsection which are connected to the first middle section; the first subsection and the second subsection having different lengths, the first subsection having a first feed point;
a secondary antenna having a second feed point which is connected therewith; and
a feeder feeding an electrical signal to the first feed point and the second feed point;
wherein the primary antenna and the secondary antenna are disposed on the circuit board, the feeder is a coaxial cable having an inner conductor, an outer conductor, and an insulator disposed between the inner conductor and the outer conductor; a first end of the inner conductor is connected to the first feed point, and a second end of the inner conductor is connected to the wireless transceiver; a first end of the outer conductor is connected to the second feed point, and a second end of the outer conductor is connected to the metal element.

17. The electronic device of claim 16, wherein the secondary antenna is n-shaped and consists of a second middle section, and a third subsection and a fourth subsection which are connected to the second middle section; the third subsection and the fourth subsection have different lengths, the third subsection has the second feed point.

18. The electronic device of claim 17, wherein the length of the first subsection is larger than the length of the second subsection, and the length of the third subsection is larger than the length of the fourth subsection.
